(19) United States
(12) Patent Application Publication
(10) Pub. No.: US 2025/0215118 A1
(43) Pub. Date: Jul. 3, 2025

(54) PROCESS FOR PRODUCING POLYMERS

(71) Applicant: ARLANXEO NETHERLANDS B.V., Geleen (NL)

(72) Inventors: Harmen Jan BOONSTRA, Sittard (NL); Ronaldus Jacobus Maria HUYPS, Sittard (NL); Wouter VAN MEERENDONK, Einighausen (NL); Gerardus VAN DOREMAELE, Munstergeleen (NL)

(73) Assignee: ARLANXEO NETHERLANDS B.V., Geleen (NL)

(21) Appl. No.: 18/850,151

(22) PCT Filed: Jun. 21, 2022
(86) PCT No.: PCT/EP2022/066839

§ 371 Date: Sep. 24, 2024

(30) Foreign Application Priority Data
May 9, 2022 (WO) PCT/EP2022/062460

(51) Int. Cl. C08F 2/01; C08F 2/00; C08F 2/06; C08F 2/18; C08F 2/38; C08F 210/18

(52) U.S. Cl. CPC C08F 2/01; C08F 2/001; C08F 2/06; C08F 2/18; C08F 2/38; C08F 210/18

(57) ABSTRACT

Process of producing a polymer comprising (i) feeding a monomer stream containing the monomers for producing the polymer into a polymerization unit comprising at least one reaction vessel where at least one reaction mixture comprising a polymer is produced in a polymerization reaction in the presence of at least one solvent and at least one catalyst, (ii) feeding at least a fraction of a reaction mixture produced in the polymerization unit comprising a polymer, catalyst and, optionally monomer, into a recycle line to form a recycle stream, (iii) reducing the temperature of the recycle stream, (iv) feeding the recycle stream, after its temperature has been reduced, into the polymerization unit, the monomer stream or both, and wherein the polymer is an elastomer selected from (a) ethylene/alpha-olefin copolymers with at least 20% by weight of units derived from ethylene and which, optionally may further comprise units derived from at least one non-conjugated diene having from 6 to 30 carbon atoms, preferably selected from dicyclopentadiene (DCPD), 5-ethylidene-2-norbornene (ENB), 5-vinyl-2-norbornene (VNB) and a combination thereof, (b) polybutadienes and (c) butadiene copolymers with at least 50% by weight of units derived from butadiene, wherein, preferably, at least one reaction vessel of the polymerization unit has a reactor volume of at least 4 liters and wherein the process, preferably, further comprises a step (v) comprising removing solvent and isolating the polymer from a reaction mixture produced in the polymerization unit, preferably by feeding a reaction mixture produced in the polymerization unit to at least one work up section for removing the solvent and isolating the polymer.

This application is a 371 of PCT/EP2022/066839, filed Jun. 21, 2022, which claims priority benefit under 35 U.S.C. § 119 of the PCT/EP2022/062460, filed May 9, 2022, the disclosures of which are incorporated herein by reference.

### FIELD

The present disclosure relates to a process for producing polymers using a polymerization catalyst and a solvent.

### BACKGROUND

Many widely used synthetic rubbers are produced by solution or slurry polymerization using one or more polymerization catalysts. For optimized mixing of catalyst and reactants the polymerizations are typically carried out in stirred tank reactor. The polymerization reaction generally is exothermic, and the catalysts are deactivated above a certain temperature threshold. Therefore, the temperature in the reactor has to be controlled and kept below the temperature at which the catalyst deactivates. Cooling the reactors by external or internal cooling devices may lead to poorer reaction control and reactor fouling as described, for example, in international patent application WO2010040732. Continuous polymerizations are typically carried out in so-called adiabatic reactors, where the reactor temperature is predominantly set by the target polymer concentration and the temperature of monomer/solvent mixture feed stream. Typically, the monomer feeds are cooled to temperatures significantly below 0° C. in one or more cooler units before they enter the reaction vessel when the temperature in the reactor shall be kept at a fixed predetermined value within the range of about 60° C. to 120° C. to allow the polymerization to proceed to form polymers of high molecular weight while avoiding deactivation of catalyst. However, cooling down monomer/solvent feeds to low temperatures consumes energy and significantly contributes to the production costs. In the process described in WO2010040732, the polymerization is carried out under boiling condition in the polymerization reactor. The cooling effect of evaporating fluids in the reactor is used to control the reactor temperature. The vapor phase from the reactor is fed into a condenser and is cooled to low temperatures in a sub-cooler before it is combined with a new monomer/solvent feed stream and fed into the reactor again. However, running the reactor at boiling conditions is also not very economical because only a part of the reactor volume is available for the polymerization. Further, condensation of the vapour phase also adds to the energy costs. In international patent application WO2016109264 a polymerization process is described that uses at least two reactors of which at least one reactor is a loop reactor. A chilled stream containing monomers, solvent and hydrogen is fed into a first reactor where a reaction mixture containing the polymer is produced. The reaction mixture is fed into a loop reactor where new chilled monomers, solvent and hydrogen are added. Catalysts are fed into the loop reactor to run a second polymerization in the loop reactor. The process is reported to reduce the load on the devolatization unit where the solvent is removed from the reaction mixture to isolate the polymer, which is reported to save energy costs. Therefore, the energy savings are achieved in this process during the work-up stage after the polymerization has taken place. In WO2020/05311A1 and WO2020/05337A1 is suggested to polymerize a feedstock in a loop reactor to produce a polyolefin product to improve heat transfer compared to stirred tank reactors. A loop reactor is described to be generally several heat exchangers in a loop. The examples provided in these documents are software simulations.

There is still a need for alternative processes to produce polymers by polymerization using at least one solvent and at least one catalyst at lower energy costs. Preferably the process is suitable to produce polymers having a high weight averaged molecular weight, for example a molecular weight of at least 50 kg/mole or at least 200 kg/mole.

### SUMMARY

Therefore, there is provided a process for producing a polymer comprising

Process of producing a polymer comprising
(i) feeding a monomer stream containing the monomers for producing the polymer into a polymerization unit comprising at least one reaction vessel where at least one reaction mixture comprising a polymer is produced in a polymerization reaction in the presence of at least one solvent and at least one catalyst,
(ii) feeding at least a fraction of a reaction mixture produced in the polymerization unit comprising a polymer, catalyst and, optionally monomer, into a recycle line to form a recycle stream,
(iii) reducing the temperature of the recycle stream,
(iv) feeding the recycle stream, after its temperature has been reduced, into the polymerization unit, the monomer stream or both,
and wherein the polymer is an elastomer selected from (a) ethylene/alpha-olefin copolymers with at least 20% by weight of units derived from ethylene and which, optionally may further comprise units derived from at least one non-conjugated diene having from 6 to 30 carbon atoms, preferably selected from dicyclopentadiene (DCPD), 5-ethylidene-2-norbornene (ENB), 5-vinyl-2-norbornene (VNB) and a combination thereof, (b) polybutadienes and (c) butadiene copolymers with at least 50% by weight of units derived from butadiene, wherein, preferably, at least one reaction vessel of the polymerization unit has a reactor volume of at least 4 liters and wherein the process, preferably, further comprises a step (v) comprising removing solvent and isolating the polymer from a reaction mixture produced in the polymerization unit, preferably by feeding a reaction mixture produced in the polymerization unit to at least one work up section for removing the solvent and isolating the polymer.

### BRIEF DESCRIPTION OF THE DRAWINGS

FIG. 1 is a schematic representation of the general process of the present disclosure.

FIG. 2 is a schematic representation of an embodiment of the process of the present disclosure where two polymerization reactors are connected in series.

FIG. 3 is a schematic representation of another embodiment of the process of the present disclosure where two reactor vessels are connected in series.

FIG. 4 is a schematic representation of an embodiment of the process of the present disclosure where two reactor vessels are connected in parallel.

### DETAILED DESCRIPTION

The process according to the present disclosure will now be described in greater detail in the following description.

In the following description the terms “comprising,” “containing”, “including,” “having,” are not intended to exclude the presence of any additional component, step or procedure, whether or not the same is specifically disclosed. The term “consisting of” is used if the presence of any additional component, step or procedure is meant to be excluded.

In the following description norms may be used. If not indicated otherwise, the norms are used in the version that was in force on Mar. 1, 2020. If no version was in force at that date because, for example, the norm has expired, the version is referred to that was in force at a date that is closest to Mar. 1, 2020.

In the following description the amounts of ingredients of a composition or polymer may be indicated by “weight percent”, “wt. %” or “% by weight”. The terms “weight percent”, “wt. %” or “% by weight” are used interchangeably and are based on the total weight of the composition or polymer, respectively, which is 100% unless indicated otherwise.

The term “phr” means parts per hundred parts of rubber, i.e. the weight percentage based on the total amount of rubber which is set to 100%.

Ranges identified in this disclosure are meant to include and disclose all values between the endpoints of the range and include the end points unless stated otherwise.

### Polymers

Polymers may be produced that have a broad or narrow molecular weight distribution (Mw/Mn). In one embodiment polymers may be produced that have a molecular weight distribution (Mw/Mn) from 1.80 to 30 or from 2 to 10.

Preferably, the polymers are elastomers (also referred to as rubbers). Elastomers can be identified, amongst others, by their Mooney viscosities—contrary to thermoplastic polymers which are typically identified by their melting points or melt viscosities. Polymers may be produced that have a high or low Mooney viscosity. In one embodiment the polymer produced by the process has a Mooney viscosity ML 1+4 at 125° C. of at least 20, preferably at least 40 and up to a Mooney viscosity ML 1+8 at 150° C. of 100. In one embodiment of the present disclosure the polymer has a Mooney viscosity ML 1+4 at 125° C. of about 40 to about 100. In another embodiment of the present disclosure, the polymer has a Mooney viscosity ML 1+8 at 150° C. of from about 50 to about 100.

Polymers of high or low weight average molecular weight (Mw) may be produced by the process according to the present disclosure, although it is an advantage of the present disclosure that also polymers of a high molecular weight can be produced, for example polymers with a molecular weight (Mw) of at least 50.000 g/mole or even at least 200.000 g/mole. In one embodiment of the present disclosure a polymer of with a molecular weight (Mw) of from 50 kg/mole to 150 kg/mole is produced. In another embodiment of the present disclosure, the polymer has an Mw of at least 200,000 g/mole, for example, from about 200,000 g/mole to about 600,000 g/mole or from about 200,000 g/mole to about 500,000 g/mole.

Polymers with a high or low number average molecular weight (Mn) may be produced. In one embodiment the polymer produced by the process according to the present disclosure has an Mn of from 40,000 g/mole to 250,000 g/mole. In one embodiment of the present disclosure the polymer produced by the process has a z-average molecular weight (Mz) of from about 100 kg/mol to 3000 kg/mol, preferably from about 200 kg/mol to about 2000 kg/mol.

Branched or linear polymers may be produced with the process according to the present disclosure. The branching level of branched polymers may be high, moderate or low. The polymer branching level can be characterized by the parameter Δδ. Δδ, expressed in degrees, is the difference between the phase angle δ at a frequency of 0.1 rad/s and the phase angle δ at a frequency of 100 rad/s, as determined by Dynamic Mechanical Spectroscopy (DMS) at 125° C. and 10% strain. This quantity Δδ is a measure for the amount of long chain branched structures in the polymer and has been introduced in H. C. Booij, Kautschuk+Gummi Kunststoffe, Vol. 44, No. 2, pages 128-130, which is incorporated herein by reference. The lower Δδ, the more branched structures are present in the polymer. In one embodiment of the present disclosure polymers with a Δδ of from 2 to 50 are produced.

The polymers produced by the process according to the present disclosure may be random polymers or block-copolymers. They may be monomodal, or they may be bimodal or multimodal, i.e. they may have molecular weight distributions featuring two peaks in case of bimodal polymers or more than two peaks in case of multimodal polymers in a diagram obtained by gel permeation chromatography (GPC). Reactor blends may be produced also, which means polymers are produced in at least two different reaction vessels and are combined by blending, typically wet blending, i.e. by blending the reaction mixtures.

It is contemplated that the process according to the present disclosure can be applied to any polymerization process to produce polymers using at least one polymerization catalyst a solvent and where the reaction is exothermic. This may include the production of thermoplastic or elastomeric polymers and may include the production of rubbers including rubbers such as EPM, EPDM, IR, BR, SBR, and HNBR. However, the process may be most useful for producing rubbers selected from (a) ethylene/alpha-olefin copolymers with at least 20% by weight of units derived from ethylene, and which, optionally, may further comprise units derived from at least one non-conjugated diene having from 6 to 30 carbon atoms, preferably selected from dicyclopentadiene (DCPD), 5-ethylidene-2-norbornene (ENB), 5-vinyl-2-norbornene (VNB) and a combination thereof, (b) polybutadienes and (c) butadiene copolymers with at least 20% by weight or at least 50% by weight of units derived from butadiene. In a preferred embodiment of the present disclosure the polymers include ethylene/alpha-olefin polymers and butadiene polymers.

### Ethylene/Alpha-Olefin Polymers

In one embodiment the polymer produced with the process according to the present disclosure is an ethylene/alpha-olefin-polymer. The ethylene/alpha-olefin-polymer is a copolymer of ethylene and an alpha-olefin and, optionally, one or more further comonomers. Ethylene/alpha-olefin polymers can be produced that comprise at least 20% by weight (based on the total weight of the polymer) of units derived from ethylene and may contain up to 80 percent by weight (wt. %) of units derived from ethylene. In one embodiment the ethylene-α-olefin-copolymer of the present disclosure comprises from 40 to 70 wt. %, preferably from 44 to 65 wt. % or from 50 to 60 wt. % of units derived from ethylene. The weight percentages are based on the total weight of the copolymer.

In addition to units derived from ethylene the polymer according to the present disclosure contains units derived from one or more alpha-olefins.

### Alpha-Olefins

Alpha-olefins are olefins having a single aliphatic carbon-carbon double bond. The double bond is located at the terminal end (alpha-position) of the olefin. The α-olefins can be aromatic or aliphatic, linear, branched or cyclic. Typically, the alpha-olefins have from 3 to 20 carbon atoms.

Alpha-olefins include those represented by the formula: H₂C═X—CH₃,
where X represents an aliphatic alkylene residue having from 1 to 17 carbon atoms which may be linear or branched. Preferably the branches contain, independently from each other, from 1 to 3 carbon atoms.

In a preferred embodiment alpha-olefins include those represented by the formula: H₂C═CH—(CH₂)ₙ—CH₃ where n= represents 1, 2, 3, 4, 5, 6, 7, 8, 9, 10, 11, 12, 13, 14, 15, 16 and 17.

Preferred examples of alpha-olefins include but are not limited to propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-hepta-decene, 1-octadecene, 1-nonadecene, 1-eicosene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 9-methyl-1-decene, 11-methyl-1-dodecene and 12-ethyl-1-tetradecene.

One or more alpha-olefins may be used in combination. Preferably, the polymer contains at least 5 wt. % or at least 10 wt. % of units derived from one or more alpha-olefin. Polymers may be produced that contain up to 57 wt. %, more preferably up to 55 wt. % of units derived from one or more alpha-olefin (the weight percentages (wt. %) are based on the total weight of the polymer). Preferably, the ethylene-α-olefin-copolymer contains from 17 to 57 wt. % of total units derived from one or more alpha-olefin. Preferably, the polymer contains propylene.

### Non-Conjugated Dienes

In addition to ethylene and alpha-olefin the ethylene/alpha-olefin polymers may be produced that also contain units derived from one or more non-conjugated diene as comonomer.

Non-conjugated dienes are polyenes comprising at least two carbon-carbon double bonds, the double bonds are non-conjugated and may be present in chains, rings, ring systems or combinations thereof. The carbon-carbon double bonds are separated by at least two carbon atoms. The polyenes may have endocyclic and/or exocyclic double bonds and may have no, the same or different substituents. Preferably, the non-conjugated dienes are aliphatic, more preferably aliphatic and alicyclic. Suitable non-conjugated dienes include, for example, aromatic polyenes, aliphatic polyenes and alicyclic polyenes, preferably polyenes with 6 to 30 carbon atoms (C₆-C₃₀-polyenes, more preferably C₆-C₃₀-dienes). Specific examples of non-conjugated dienes include but are not limited to 1,4-hexadiene, 3-methyl-1,4-hexadiene, 4-methyl-1,4-hexadiene, 5-methyl-1,4-hexadiene, 4-ethyl-1,4-hexadiene, 3,3-dimethyl-1,4-hexadiene, 5-methyl-1,4-heptadiene, 5-ethyl-1,4-heptadiene, 5-methyl-1,5-heptadiene, 6-methyl-1,5-heptadiene, 5-ethyl-1,5-heptadiene, 1,6-octadiene, 4-methyl-1,4-octadiene, 5-methyl-1,4-octadiene, 4-ethyl-1,4-octadiene, 5-ethyl-1,4-octadiene, 5-methyl-1,5-octadiene, 6-methyl-1,5-octadiene, 5-ethyl-1,5-octadiene, 6-ethyl-1,5-octadiene, 1,6-octadiene, 6-methyl-1,6-octadiene, 7-methyl-1,6-octadiene, 6-ethyl-1,6-octadiene, 6-propyl-1,6-octadiene, 6-butyl-1,6-octadiene, 4-methyl-1,4-nonadiene, 5-methyl-1,4-nonadiene, 4-ethyl-1,4-nonadiene, 5-ethyl-1,4-nonadiene, 5-methyl-1,5-nonadiene, 6-methyl-1,5-nonadiene, 5-ethyl-1,5-nonadiene, 6-ethyl-1,5-nonadiene, 6-methyl-1,6-nonadiene, 7-methyl-1,6-nonadiene, 6-ethyl-1,6-nonadiene, 7-ethyl-1,6-nonadiene, 7-methyl-1,7-nonadiene, 8-methyl-1,7-nonadiene, 7-ethyl-1,7-nonadiene, 5-methyl-1,4-decadiene, 5-ethyl-1,4-decadiene, 5-methyl-1,5-decadiene, 6-methyl-1,5-decadiene, 5-ethyl-1,5-decadiene, 6-ethyl-1,5-decadiene, 6-methyl-1,6-decadiene, 6-ethyl-1,6-decadiene, 7-methyl-1,6-decadiene, 7-ethyl-1,6-decadiene, 7-methyl-1,7-decadiene, 8-methyl-1,7-decadiene, 7-ethyl-1,7-decadiene, 8-ethyl-1,7-decadiene, 8-methyl-1,8-decadiene, 9-methyl-1,8-decadiene, 8-ethyl-1,8-decadiene, 1,5,9-decatriene, 6-methyl-1,6-undecadiene, 9-methyl-1,8-undecadiene, dicyclopentadiene, and mixtures thereof. Preferred non-conjugated dienes include alicyclic polyenes. Alicyclic dienes have at least one cyclic unit. In a preferred embodiment the non-conjugated dienes are selected from polyenes having at least one endocyclic double bond and optionally at least one exocyclic double bond. Preferred examples include dicyclopentadiene, 5-methylene-2-norbornene and 5-ethylidene-2-norbornene (ENB) with ENB being particularly preferred. In one embodiment the copolymer of the present disclosure contains only ENB as non-conjugated diene.

Further examples of non-conjugated dienes include dual polymerizable dienes, which include alpha-omega-dienes, preferably linear alpha-omega-dienes, vinyl substituted monocyclic and bicyclic non-conjugated dienes, which may be aromatic or aliphatic. Such dual polymerizable dienes may cause or contribute to the formation of polymer branches because both double bonds of the diene may take part in the polymerization. Examples of aliphatic dual polymerizable dienes include, but are not limited to, 1,4-divinylcyclohexane, 1,3-divinylcyclohexane, 1,3-divinylcyclopentane, 1,5-divinylcyclooctane, 1-allyl-4-vinylcyclo-hexane, 1,4-diallyl cyclohexane, 1-allyl-5-vinylcyclooctane, 1,5-diallylcyclooctane, 1-allyl-4-isopropenyl-cyclohexane, 1-isopropenyl-4-vinylcyclohexane and 1-isopropenyl-3-vinylcyclopentane, dicyclopentadiene (DCPD) and 1,4-cyclohexadiene. Preferred are non-conjugated vinyl norbornenes and C₈-C₁₂ alpha omega linear dienes (e.g., 1,7-octadiene, 1,8-nonadiene, 1,9-decadiene, 1,10-undecadiene, 1,11-dodecadiene). The dual polymerizable dienes may be further substituted with at least one group comprising a heteroatom of group 13-17 for example O, S, N, P, Cl, F, I, Br, or combinations thereof.

In a preferred embodiment of the present disclosure the dual polymerizable diene is selected from, dicyclopentadiene (DCPD), 5-vinyl-2-norbornene (VNB), 1,7-octadiene and 1,9-decadiene or a combination thereof, with 5-vinyl-2-norbornene (VNB) being most preferred.

Examples of aromatic non-conjugated polyenes include vinylbenzene (including its isomers) and vinyl-isopropenylbenzene (including its isomers).

In a typical embodiment of the present disclosure ethylene/alpha-olefin copolymers can be produced that contain at least 3 wt. % and up to and including 15 wt. % of units derived from one or more non-conjugated diene.

In another embodiment polymers are produced that contain non-conjugated dienes selected from, dicyclopentadiene (DCPD), 5-ethylidene-2-norbornene (ENB), 5-vinyl-2-norbornene (VNB), 1,7-octadiene or 1,9-decadiene or a combination thereof. Preferably, the copolymer of the present disclosure contains from 0.05 wt. % to 5 wt. %, more preferably from 0.10 wt. % to 3 wt. % or from 0.15 wt. % to 1.2 wt. % of units derived from VNB (all weight percentages are based on the total weight of ethylene-α-olefin-copolymer). In another embodiment ethylene/α-olefin-copolymer can be produced that contains units derived from 5-ethylidene-2-norbornene and 5-vinyl-2-norbornene, for example the ethylene/alpha-olefin-copolymers produced may contain from 2 to 15 wt. % of units derived from ENB and from 0.05 to 4 wt. % of units derived from VNB.

Ethylene/α-olefin-copolymers can be produced by the process according to the present disclosure that may or may not contain units derived from other comonomers. The sum of units derived from ethylene, alpha-olefin and, optionally, non-conjugated diene may be greater than 90 wt. %, greater than 99 wt. % and including 100 wt. % based on the total weight of the ethylene/alpha-olefin polymer.

### Butadiene Polymers

In one embodiment of the present disclosure the polymer is a butadiene polymer. Butadiene polymers include homopolymers and copolymers of 1,3-butadiene. Preferably, the butadiene polymers contain at least 20%, preferably at least 50% by weight, preferably at least 60% by weight, based on the weight of the polymer, of units derived from 1,3-butadiene. In one embodiment of the present disclosure the diene polymers contain at least 60% by weight, or at least 75% by weight units derived from 1,3-butadiene. The butadiene polymers may contain from 0 to 49% by weight, or from 0% to 40% by weight, based on the total weight of the polymer, of units derived from one or more comonomers.

Suitable comonomers include, but are not limited to, conjugated dienes, preferably having from 5 to 24, more preferably from 5 to 20 carbon atoms.

Specific examples of conjugated dienes include, but are not limited to isoprene, 1,3-pentadiene, 2,3-dimethylbutadiene, 1-phenyl-1,3-butadiene, 1,3-hexadiene, myrcene, ocimene, farnesene and combinations thereof.

Suitable comonomers also include vinylaromatic comonomers, preferably vinyl aromatic comonomers having from 8 to 30 carbon atoms. Specific examples of vinylaromatic comonomers include, but are not limited to, styrene, ortho-methylstyrene, meta-methylstyrene, para-methylstyrene, para-butylstyrene, vinylnaphthalene, divinylbenzene, trivinylbenzene, divinylnaphthalene and combinations thereof.

Suitable comonomers further include one or more alpha-olefins, for example, ethene, propene, 1-butene, 1-pentene, 1-hexene, 4-methyl-1-pentene, 1-octene and combinations thereof.

In one embodiment, the diene polymers according to the present disclosure contain from 0 to 20% by weight of units derived from ethene, propene, 1-butene, 1-pentene, 1-hexene, 4-methyl-1-pentene, 1-octene and combinations thereof.

Suitable comonomers also include, but are not limited to, one or more other co-polymerizable comonomers that introduce functional groups including cross-linking sites, branching sites, branches or functionalized groups. In one embodiment of the present disclosure the diene polymers contain from 0% to 10% by weight or from 0% to 5% by weight of units derived from one or more of such other comonomers.

Combinations of one or more of the comonomers of the same chemical type as described above as well as combinations of one or more comonomers from different chemical types may be used.

### Solvents

The polymerization is preferably carried out in the presence of at least one solvent. Preferably, the polymerization is carried out as solution polymerization. Preferred solvents include one or more inert hydrocarbon solvent. Suitable solvents include C₅₋₁₂ hydrocarbons such as pentane, hexane, heptane, octane, cycloheptane, cyclohexane, methylcyclohexane, methylcycloheptane, pentamethyl heptane, hydrogenated naphtha, isomers and mixtures thereof. In another embodiment the polymerization is carried out as a slurry polymerization. This may be typically used when catalysts are provided on a solid support, that does not dissolve under the polymerization conditions.

### Chain Transfer Agents

In a preferred embodiment the polymerization includes the use of one or more chain transfer agents to control the molecular weight of the polymer. A preferred chain transfer agent includes hydrogen (H₂). Other chain transfer agents include but are not limited to ethane, diethyl zinc and combinations thereof.

### Catalysts

The polymers may be produced by using one or more than one conventional polymerization catalysts, suitable for use in the polymerization of the respective polymer to be produced. Typical examples include Ziegler-Natta-catalysts, organometallic catalysts or metallocene-type catalysts. Ziegler-Natta catalysts are polymerization catalysts based on halides of transition metals, in particular titanium or vanadium.

Organometallic catalysts, in particular organometallic catalysts including nickel, cobalt, titanium or rare earth metals are typically used to produce butadiene polymers. Rare earth catalysts include organometallic compounds including neodymium, praseodymium, cerium, lanthanum, gadolinium and dysprosium or a combination thereof.

Examples of suitable catalysts are disclosed in Canadian patent application CA 1,143,711 A, U.S. Pat. No. 4,260,707, US patent application No US2013/0172489 A1 or as described in paragraphs [0011] to [0049] of EP 2 819 853 A1, all incorporated herein by reference.

Metallocene-type catalysts are organometallic catalysts wherein a metal, typically Ti, Hf, or Zr, is bonded to at least one cyclic organic ligand, preferably at least one cyclopentadienyl-based, fluorenyl-based or indenyl-based ligand. Catalysts where the metal is bonded to two anionic aromatic ligands are typically referred to in the art as “metallocene catalysts”. Catalysts wherein the second anionic aromatic ligand is replaced by another organic ligand are referred to as “half-metallocene catalysts”. Metal catalysts where both anionic ligands are replaced with organic residues are referred to in the art as “post-metallocene catalysts”. Metallocene-type catalysts include metallocene, post-metallocene and half-metallocene catalysts. Suitable metallocene-type polymerization catalysts are known in the art and are described in, for example, WO2005/090418 A1, WO2016/114914A1, WO2017/048448, US2015/0025209A1, all incorporated herein by reference.

Typically, one or more cocatalysts are added to the reaction vessel. Typical cocatalysts include but are not limited to boron containing activators. In a preferred embodiment the activators (b) are selected from boranes (C1) or borates (C2 or C3).

Suitable boron activators (C1) can be represented by the general formula BQ₁Q₂Q₃.

Suitable borate activator according to (C2) can be represented by the general formula G(BQ₁Q₂Q₃Q₄).

Suitable borate activators according to (C3) can be represented by the general formula (J-H)(BQ₁Q₂Q₃Q₄),

In the activator according to (C1) B is boron and Q₁ to Q₃ are substituted or unsubstituted aryl groups, preferably phenyl groups. Suitable substituents include but are not limited to halogens, preferably fluoride, and C₁ to C₄₀ hydrocarbyls, preferably C₁ to C₂₀ alkyls or aromatics. Specific examples of activators according to (C1) include tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, phenyl-bis(pentafluoro-phenyl)borane and the like.

In the activator according to (C2) G is an inorganic or organic cation, B is boron and Q₁ to Q₃ are the same as in (C1) and Q₄ is also a substituted or unsubstituted aryl group, preferably a substituted or unsubstituted phenyl. Substituents include but are not limited to halogens, preferably fluoride, and C₁ to C₄₀ hydrocarbyls, preferably C₁ to C₂₀ alkyls or aromatics. Specific examples for the borate group (BQ₁Q₂Q₃Q₄) include but are not limited to tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, teterakis(2,3,4-trifluorophenyl)borate, phenyltris(pentafluoro-phenyl) borate, tetrakis(3,5-bistrifluoromethylphenyl)borate and the like. Specific examples of G include a ferrocenium cation, an alkyl-substituted ferrocenium cation, silver cation and the like. Specific examples of an organic cation G include a triphenylmethyl cation and the like. G is preferably a carbenium cation, and particularly preferably a triphenylmethyl cation.

In the activator according to (C3) J represents a neutral Lewis base, (J-H) represents a Bronsted acid, B is a boron and both Q₁ to Q₄ and the borate group (BQ₁Q₂Q₃Q₄) are the same as in (C2). Specific examples of the Bronsted acid (J-H) include a trialkyl-substituted ammonium, N,N-dialkylanilinium, dialkylammonium, triaryl phosphonium and the like. Specific examples of activators according to (C3) include but are not limited to triethylammoniumtetrakis(pentafluoro-phenyl)-borate, tripropylammoniumtetrakis(pentafluorophenyl)borate, tri(n-butyl)ammonium-tetrakis(pentafluorophenyl)borate, tri(n-butyl)ammoniumtetrakis(3,5-bistrifluoromethyl-phenyl)borate, N,N-dimethyl-aniliniumtetrakis(pentafluoro-phenyl)borate, N,N-diethylaniliniumtetrakis(penta-fluorophenyl)borate, N,N-2,4,6-pentamethylanilinium-tetrakis(pentafluorophenyl)borate, N,N-dimethylanilinium-tetrakis(3,5-bistrifluoromethyl-phenyl)borate, diisopropyl-ammoniumtetrakis(penta-fluorophenyl)borate, dicyclohexyl-ammoniumtetrakis-(pentafluorophenyl)borate, triphenylphosphoniumtetrakis(penta-fluorophenyl)borate, tri(methylphenyl)phosphoniumtetrakis(pentafluorophenyl)borate, tri(dimethylphenyl)-phosphonium-tetrakis(pentafluorophenyl)borate and the like.

Other cocatalysts include but are not limited to aluminium alkyls such as trialkyl aluminium, trimethyl aluminium, triethyl aluminium, tri-isobutyl aluminium, or tri-n-octylaluminium. Other examples include but are not limited to alkyl aluminium halides, such as diethyl aluminium chloride, dimethyl aluminium chloride, and ethyl aluminium sesquichloride and alumoxanes, such as methyl alumoxane (MAO), tetraisobutyl alumoxane (TIBAO) or hexaisobutyl alumoxane (HIBAO). The cocatalysts are also referred to in the art as “activators”. The presence of cocatalysts typically increases the rate at which the catalyst polymerizes the olefins. The cocatalyst can also affect the molecular weight, degree of branching, comonomer content, or other properties of the polymer. The cocatalyst is typically introduced into the reactor together with the catalyst.

### Scavengers

Impurities can harm catalysts by reducing their activity. Compounds that react with such impurities and turn them into harmless compounds for catalyst activity are referred to as scavengers by one skilled in the art of polymerization. Scavengers can be optionally fed to the reactor(s) of the process disclosed herein. Non-limiting exemplary scavengers include alkyl aluminium compounds, such as trimethyl aluminium, triethyl aluminium, tri-isobutyl aluminium, and trioctyl aluminium. The scavenger can be the same compound as a cocatalyst and in that case it is generally applied in excess of what is needed to fully activate the catalyst. The scavenger can also be introduced to the reactor with the monomer feed or separately from it via any other feed stream.

The scavenger can be used in combination with a sterically hindered hydrocarbon, preferably a sterically hindered phenol, containing a group 15 or 16 heteroatom, (preferably O, N, P and S atoms, more preferably O and N heteroatoms). Specific examples of sterically hindered hydrocarbons include but are not limited to tert-butanol, iso-propanol, triphenylcarbinol, 2,6-di-tert-butylphenol, 4-methyl-2,6-di-tert-butylphenol, 4-ethyl-2,6-di-tert-butylphenol, 2,6-di-tert-butylanilin, 4-methyl-2,6-di-tert-butylanilin, 4-ethyl-2,6-di-tert-butylanilin, diisopropylamine, di-tert-butylamine, diphenylamine and the like.

### Process

The process of producing the polymers comprises
(i) feeding a monomer stream containing the monomers for producing the polymer into a polymerization unit comprising at least one reaction vessel where at least one reaction mixture comprising a polymer is produced in a polymerization reaction in the presence of at least one solvent and at least one catalyst,
(ii) feeding at least a fraction of a reaction mixture produced in the polymerization unit comprising a polymer, catalyst and, optionally monomer, into a recycle line to form a recycle stream comprising the reaction mixture,
(iii) reducing the temperature of the recycle stream,
(iv) feeding the recycle stream, after its temperature has been reduced, into the polymerization unit, the monomer stream or both,
and wherein the process, preferably, further comprises a step (v) comprising feeding a reaction mixture produced in the polymerization unit to at least one work up section for removing the solvent and isolating the polymer.

The process according to the present disclosure involves the recycling of at least a fraction of a reaction mixture generated in a polymerization reactor. The reaction mixture used for recycling is cooled down before it is reintroduced into the reactor directly or indirectly for further polymerization. This reduces the need to cool the monomer/solvent streams to very low temperatures, avoids the use of expensive cooling equipment and the overall energy consumption can be reduced. The recycling part of the polymerization process comprises at least the following steps (ii), (iii) and (iv), which may be carried out as a one-time step or repeatedly, for example continuously, or intermittently, preferably continuously:
(ii) feeding at least a fraction of a reactive reaction mixture produced in the polymerization unit containing polymer into a recycle line to form a recycle stream for (re)introducing the reactive reaction mixture either into a reaction vessel of the polymerization unit or into the monomer stream;
(iii) reducing the temperature of the recycle stream;
(iv) introducing the recycle stream into at least one reaction vessel of the polymerization unit, into the monomer stream or a combination thereof, for example by dividing the recycle stream.

The recycle stream may be introduced directly into the reaction vessel of the polymerization unit. Alternatively, or in addition, the recycle stream may be introduced into the reaction vessel indirectly. For example, the recycle stream may be combined with the monomer stream to produce a reactant stream and the recycle stream is fed into at least one reaction vessel as part of the reactant stream. The recycle stream contains a reaction mixture produced in the polymerization unit. This reaction mixture contains polymer and catalyst. The reaction mixture fed into the recycle stream may contain at least 5% by weight, based on the total weight of the reaction mixture, of polymer. In one embodiment of the present disclosure the reaction mixture fed into the recycling stream comprises from 5% to 15% by weight o polymer. The reaction mixture in the recycle stream may, optionally also comprise monomer, and optionally, also comprise solvent. The reaction mixture in the recycle stream comprises a catalyst and is still reactive. The polymerization reaction may continue in the recycle stream, although the polymerization reaction may be suppressed or its reaction speed may be reduced, for example by adding one or more chain transfer agents to the recycle stream, or by increasing the flow speed of the recycle stream or the length of the recycle line.

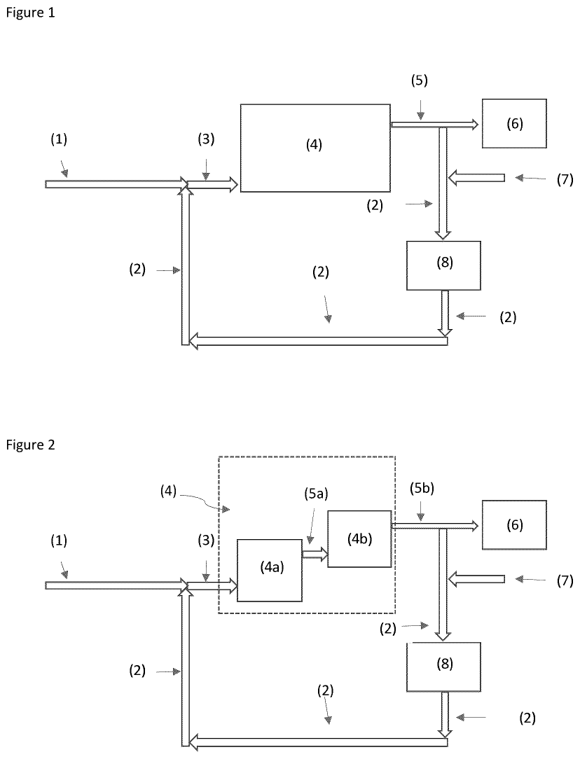

The process according to the present disclosure will now be described in greater detail by referring to FIG. 1 for illustration:

A monomer stream (1) containing the monomers for making the ethylene/alpha-olefin copolymer is produced. Preferably, the monomer stream (1) is a single stream and preferably contains all different types of monomers needed to produce the copolymer. Instead of single monomer stream, several, same or different monomer feed streams may be used also. Preferably, the monomer stream also comprises solvent. Preferably monomers and solvent are fed to the polymerization (4) unit together in one feed stream. The first monomer feed stream (1) may also contain one or more chain transfer agents or both. In one embodiment of the present disclosure all fresh solvent is introduced to at least one reaction vessel as part of the monomer stream. The first monomer feed stream (1) is chilled to a first temperature T1. Typically, T1 may include a temperature of from −30° to +39° C., or from greater than −25° C. and up to +39° C. Preferably T1 is from −15° C. and up to +25° C. or from −10° C. to +20° C. Preferably, the monomer stream is pressurised to maintain the monomers in the liquid state and/or dissolved in solvent.

The monomer feed stream (1) is introduced into the polymerization unit (4). The polymerization unit is the section of the process where the polymer is produced. The polymerization unit may contain one or more than one reaction vessel and in each of the reaction vessels a polymerization reaction may be carried out. In case a plurality of reaction vessels is used the vessels may be connected in series or in parallel or a combination thereof. The reaction vessel has at least one device for mixing the reactor content or at least a part of the reactor content. A typical reaction vessel includes a stirred tank reactor, preferably a continuously stirred tank reactor (CSTR), which means reactor content is continuously stirred during the polymerization reaction. Such reactors are known in the art. Typically, a stirred tank reactor is a pressure reactor vessel containing one or more rotating agitators, and/or one or more impellers, preferably on a central agitator shaft, which are used to mix the reactor contents. Examples of impellers include but are not limited to INTERMIG, VISCOPROP and VARIOBLADE from Ekato Systems GmbH. Typically, one or more baffles are often installed on the wall of the reactor to improve the quality of mixing. However, other types of reaction vessels with mixing elements suitable for solution or slurry polymerization other than stirred tank reactors may be used also. The process can be used at a small scale or at an industrial scale where, preferably, at least one reactor is used that has a reactor volume of greater than 3 litres, for example having a volume of from about 4 to 4000 litres. Preferably, when run at industrial scale where the polymerization unit has at least one reactor that has a reactor volume of from about 4 to 4000 litres and the process is run continuously. Typically, one or more feed streams (1) introduce the reactants into at least one reaction vessel, and an exit stream (5) is used to withdraw the reactor effluent. Typically, chain transfer agent, solvent, catalyst, and monomer feeds are introduced at one or more points within the reaction vessel using various types of feed injectors. Typically, one or more catalyst components are introduced, in a similar fashion, via one or more catalyst injectors and separately from the monomers. Chain transfer agent and solvent may be introduced separately from the monomer stream but preferably have been added to the monomer stream beforehand and are introduced into the reactor as components of the monomer stream. Scavengers are preferably introduced via the monomer stream (1). In case of connected reaction vessels, reaction mixture from one reaction vessel may be fed into the other reaction vessel instead or in addition to fresh monomer stream.

Mixers are frequently used downstream of each feed or catalyst injector, to improve mixing of these feed streams into the bulk fluid.

The reactors may be jacketed, to allow addition or removal of heat. The reactor may contain cooling coils to aid in the remove of the heat of polymerization. Preferably the reactor is operated adiabatically. When the reactor is run adiabatically there is limited to no removal or addition of heat by internal or external heating or cooling devices. For example, less than 20%, less than 10% or even 0% of the temperature in the reactor is created (or removed or both) by external or internal heating or cooling devices. Instead, the temperature in the reactor is controlled completely or predominantly by the exothermic reaction, the temperature and flows of reactants and effluents, the temperature and flow speed of the reactant stream(s) entering the reactor, the residence time in the reactor and the temperature and flow speed of the effluents leaving the reactor or a combination thereof. Typically, condensation of a gas phase generated in the reactor is not used to remove heat from the reaction vessel. Preferably, the reactor is operated such that the formation of condensable monomer gas is prevented, i.e. the reactor is operated such that the monomers are kept dissolved in solvent or are kept in the liquid state. For example, the reactor may contain sufficient amounts of solvent and may be operated under sufficient pressure to prevent the formation of monomer gas. For example, the reactor may be filled with at least 50%, or at least 75%, preferably at least 90% or even at 95% based on the available reactor volume by solvent or liquids in general, including for example ingredients like reactants, solvent and reaction product in liquid, dissolved, suspended or in dispersed form. Preferably the polymerization unit and the recycle line are operated under sufficient pressure such that (unused and fresh) monomers are kept dissolved in the solvent or are kept in liquid state or both. In one embodiment of the present disclosure also the solvent is kept in a liquid state in the reactor.

In the process according to the present disclosure, the polymerization unit (4) contains at least one reaction vessel that is preferably operated as a stirred tank reactor. Typically, a temperature T4 of from about 50° C. to 160° C., or from 60° C. to 120° C., may be reached in at least one reaction vessel of the polymerization unit during the polymerization. The temperature is adapted to the polymerization speed and polymers to be produced and may depend on the reaction system used. However, the process is run such that the temperature in the reaction vessel where the polymerization is carried out is below the temperature at which the catalyst used in the polymerization deactivates.

The residence time of the reactants in the polymerization unit (4) is adapted to produce a reaction mixture containing the desired polymer in desired amounts. In addition to the polymer the reaction mixture may comprise solvent and may also comprise unreacted monomers and, optionally, chain transfer agent, catalyst and further components.

An exit stream (5) (also referred to herein as “product stream”) removes the reactor effluent comprising the reaction mixture obtained by the polymerization reaction. The reaction mixture may be fed to subsequent reactors for further polymerization with or without fresh monomers being added and/or with or without fresh or different catalysts being added, or it may be sent directly without passing through other reactors to at least one work up section (6) where the polymer is isolated from the reaction mixture. The work up section (6) may contain a devolatilization unit where the solvent is removed, for example by one or more stripper. The work up unit may contain one or more vessel, pumps and mixers for work up of the polymer or for mixing in additional ingredients like for example extender oils or other additives. The solvent and unreacted monomers may be recycled and reused in the polymerization process. Prior to entering the work up section (6), or within the work up section (6), the catalyst contained in the exit stream (5) may be killed by adding a polar component like water, alcohols, acids, esters, O₂, CO, CO₂ or any component known to react with the catalyst and to stop the polymerization. One or more extender oils may be added to the reaction mixture before the solvent is removed if oil-extended polymers are to be produced as known in the art. Suitable extender oils include, but are not limited to, petroleum oils, such as aromatic and naphthenic oils; polyalkylbenzene oils; organic acid monoesters, such as alkyl and alkoxyalkyl oleates and stearates; organic acid diesters, such as dialkyl, dialkoxyalkyl, and alkyl aryl phthalates, terephthalates, sebacates, adipates, and glutarates; glycol diesters, such as tri-, tetra-, and polyethylene glycol dialkanoates; trialkyl trimellitates; trialkyl, trialkoxyalkyl, alkyl diaryl, and triaryl phosphates; chlorinated paraffin oils; coumarone-indene resins; pine tars; vegetable oils, such as castor, tall, rapeseed, and soybean oils and esters and epoxidized derivatives thereof; and the like.

At least a fraction of the reaction mixture produced in the polymerization unit (4) is fed as recycle stream (2) into at least one recycling line. For example, from 1% to 95%, or from 10% to 50% (volume percent based on the total volume of reaction mixture) of the reaction mixture may be used for recycling. The fraction of the reaction mixture used for recycling may be taken directly from the reactor or, as illustrated in FIG. 1, or it may be taken from the product stream (5) before additives to kill/deactivate the catalyst are added to the product stream. In one embodiment the recycle stream (2) is taken from the product stream. From 1% to 95% of the product stream, preferably from 10% to 50% (volume percent based on the total volume of the product stream), may be taken for the recycle stream. In one embodiment of the present disclosure the recycling process is run intermittently and 100% of the product stream is used for at least one recycling cycle. The recycle stream (2) is fed to the cooling unit and subsequently to a monomer stream or a reaction vessel, or a combination thereof, in at least one recycle line. The recycle line may contain one or more pumps for forwarding the recycle stream (2) through the recycle line. Pumps as known in the art for transporting polymerization reaction mixtures may be used. Forwarding may also, or additionally, be achieved by using pressure differentials or other means as known in the art. The recycle line typically has a diameter that is smaller than the diameter of the reaction vessel. The total volume of the recycle line may be smaller or larger than the reactor volume of the at least one reaction vessel, or the volumes may be the same.

The reaction mixture may be removed from the reactor and/or product line for continuous or discontinuous recycling. For example, the reaction mixture may be subjected to recycling at certain intervals only. The product stream may be fed to the work up section (6) continuously or discontinuously. For example, the product stream to the work up section (6) may be discontinued at intervals and instead may be used for recycling. Preferably, the process is run continuously and both, product stream (5) and recycle stream (2), are operated continuously.

In one embodiment of the process according to the present disclosure steps (ii) to (iv) are carried out once or more than once before a reaction mixture produced in the polymerization unit is subjected to work up for removing solvent and isolating the polymer. This may be carried out in a batch process but also in a continuous process. In one embodiment of the present disclosure the recycling steps (ii) to (iv) may be carried out simultaneously with step (v) which comprises feeding a reaction mixture produced in the polymerization unit to at least one work up unit for removing the solvent and isolating the polymer, for example in a continuous process. In one embodiment of the process according to the present disclosure the recycling steps (ii), (iii) and (iv) are carried out at last once or more than once before step (v) is carried out.

Before the recycle stream is introduced directly or indirectly into the polymerization units for taking part in the polymerization reaction, the temperature of the recycle stream (2) is reduced in the cooling unit (8). In the cooling unit (8) the temperature of the recycle stream (2) may be reduced by means of one or more cooling devices. Preferably the cooling unit (8) contains at least one heat exchanger. A single heat exchanger or a plurality of heat exchangers, which may be connected in series or in parallel, may be used. Instead of a heat exchanger, or in addition to a heat exchanger, one or more other devices for reducing the temperature may be used, but heat exchangers are preferred. Before its temperature is reduced the recycle stream (2) may have about the same temperature as the reaction vessel from which it originates. For example, before cooling in the cooling unit (8) the recycling stream (2) may have a temperature T4 of from about 60° C. to about 120° C. In the cooling unit (8) the temperature of the recycle stream (2) is reduced to a temperature T2. Typically, the temperature T2 of the recycle stream (2) is below the temperature of the reaction vessel of the polymerization unit into which the recycle stream (2) will be fed. The temperature T2 may be the same as the temperature T1 of the monomer stream (1), or it may be greater than the temperature T1 or it may be below temperature T1. Examples of temperature T2 include but are not limited to temperatures of from 10° C. to 90° C. In one embodiment of the present disclosure the temperature of recycle stream (2) is reduced to a temperature T2 of between 20° C. and 85° C. After it has been cooled down to temperature T2, the recycle stream (2) is introduced to the polymerization unit directly or indirectly. This may be carried out in different ways. In the embodiment illustrated in FIG. 1 the recycle stream is combined with the monomer stream (1) to generate the reactant stream (3). The recycle stream is then introduced indirectly, as part of the reactant stream (3), into at least one reaction vessel of the polymerization unit (4) to produce polymer. Alternatively, or additionally, the recycle stream (2) may be fed directly into a reaction vessel of the polymerization unit (4) to produce polymer without being combined with the monomer stream (1).

In the embodiment illustrated in FIG. 1 the recycle stream (2) is combined with the monomer stream (1) after its temperature has been reduced to temperature T2 and before it is fed together with the monomer stream as reactant stream (3) into a reaction vessel of the polymerization unit (4). In this embodiment of the present disclosure the temperature of the recycle stream (2) may be reduced to a temperature (T2) of from about 20° C. to 80° C. before it is combined with the monomer stream (1), which is lower than the temperature at which the reaction vessel is operated to which the reactant stream is fed. The temperature T2 in this embodiment is higher than the temperature (T1) of the monomer stream (1). Typically, the monomer stream of the process according to the present disclosure has a temperature T1 that may be greater than −25° C. and up to +39° C. In one embodiment of the present disclosure the monomer stream has a temperature T1 from −15° C. and up to +25° C. or from −10° C. to +20° C. In one embodiment of the present disclosure the temperature of the recycle stream (2) has been reduced to a temperature (T2) of from about 20° C. to 80° C. at which it is combined with the monomer stream (1) or introduced directly into a reactor vessel or both and wherein the temperature of the monomer stream (T1) is greater than −25° C. and up to +39° C. and preferably T1 is from −15° C. and up to +25° C. or from −10° C. to +20° C.

In the embodiment illustrated in FIG. 1, the recycle stream (2) is combined with the monomer stream (1). By mixing monomer and recycle streams the resulting reactant stream (3) may reach a temperature T3 before it enters a reaction vessel of the polymerization unit (4). Typically, the temperature T3 of the reactant stream (3) is greater than the temperature T1 of the monomer stream (1). Typically, the temperature T3 is lower than the temperature of the recycle stream (T2) when it is combined with the monomer stream (1) and typically T3 is lower than the temperature at which the reaction vessel is operated into which the reactant stream (3) is fed. The temperature T3 may be, for example, from 10° C. to 90° C. The temperature of the reactant stream (T3) can be adjusted by measures including controlling the volume and/or flow speed of the monomer (1) and recycle streams (2) and controlling the temperatures T1 and T2. Additionally, or alternatively, the temperature T3 of the reactant stream (3) can be raised or lowered by external means, for example heat exchangers, heating units or cooling units but this may not be necessary and may be undesired because of the additional energy costs.

The recycle stream (2) may comprise polymer, unreacted monomers, catalyst and activators, and may be reactive. The polymerization reaction may continue within the recycle stream (2). The recycle stream may comprise, for example from 5 to 15% by weight of polymer of from 1% to 10% by weight or from 2% to 20% by weight of polymer, based on the total weight of the recycle stream. However, while continued polymerization in the recycle stream can be tolerated or desired because the recycle stream is to be reintroduced into the polymerization unit, preferably polymerization in the recycle line is suppressed, reduced or slowed down as it may lead to clogging and reactor fouling in the recycle line, and in particular in the cooling unit. This can be achieved by various measures which may be taken alone or in combination. Preferably, no additional catalyst, activator or both are added to the recycling stream (2), at least not until the recycling stream (2) has passed the cooling unit (8). Preferably, the residence time of the recycle stream (2) is shorter than the residence time in the polymerization unit (4). The residence time of the recycle stream (2) may be, for example, 1.5 to 150 times shorter than the residence time of the polymerization unit (4). The residence time of the recycle stream (2) is measured between the point where the reaction mixture is taken for recycling and fed into the recycle line to the point where the recycle stream is introduced into a reaction vessel of the polymerization unit or to the point where the recycle stream is combined with monomer stream. The retention time of polymerization unit is measured from the point of entry of monomer stream to the first reaction vessel of the polymerization unit until the point of exit of the final polymer from reaction vessel. The retention time can be calculated or measured experimentally by methods as known in the art. Preferably, the flow rate of the recycle stream (2) is faster than the flow rate of the monomer stream (1). In one embodiment of the present disclosure the flow rate of the recycle stream (2) may be at least 1.5 faster than the flow rate of the monomer stream (1), for example 1.5 to 15 times faster. The recycle line may contain one or more pumps to control or to adjust the flow rate of the recycle stream (2). Alternatively, or additionally, one or more chain transfer agents (CTA) may be added to the recycle stream (2) to reduce or completely suppress the formation of long polymer chains. Preferably, the additional chain transfer agents are fed to the recycle stream (2) via the optional CTA feed stream (7) as illustrated in FIG. 1. Preferably, the chain transfer agent (CTA) is added to the recycle stream (2) before or while the recycle stream (2) is cooled down in the cooling section (8). The chain transfer agent that is added in feed stream (7) may be the same chain transfer agent that may be added to the monomer stream (1) or it may be a different CTA. If chain transfer agent is added to the recycle stream, it may be introduced with the recycle stream (2) or reactant stream (3) into the polymerization unit (4). Therefore, the total amount of CTA in the recycle stream have to be taken into consideration and fresh addition of CTA to the monomer stream (1) or to the reaction unit (4) may have to be adjusted, for example reduced or discontinued, when chain transfer agent is added to the recycle stream.

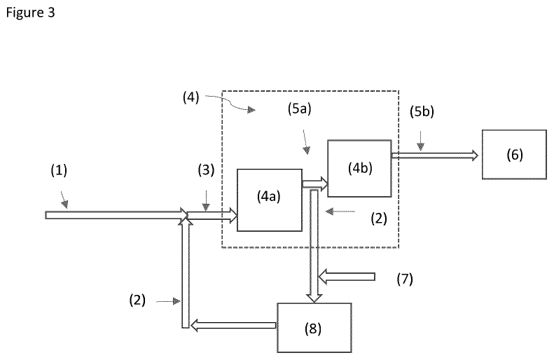

In a process where reaction vessels are connected in series the reaction mixture generated in the first reactor vessel and comprising a first polymer may be fed into at least a second reaction vessel to produce at least a second reaction mixture comprising a second polymer. The volume of the vessels may be the same or different. The residence times in the vessels may also be the same or different. Mixers in the vessels may be the same or different and mixing speed may be the same of different. For the recycling part of the process the first or the at least second reaction mixture or both may be used. Such processes allow, for example, for the production of monomodal polymers and for multimodal polymers, for example when different catalysts are used in the first and second reaction vessel. Embodiments of the process according of the present disclosure with reactors connected in series are illustrated in FIGS. 2 and 3.

The process shown in FIG. 2 is in principle identical to that illustrated in FIG. 1 except that the polymerization unit (4) contains a first reaction vessel (4a) and a second reaction vessel (4b). The effluent (5a) containing a first reaction mixture containing polymer produced in the first reaction vessel (4a) is fed into the second reaction vessel (4b) for further polymerization. In one embodiment of the present disclosure one of the following is added to the second reaction vessel (4b): reaction mixture obtained in the first reaction vessel, fresh monomer, fresh solvent, catalyst and optional ingredients or a combination thereof. In another embodiment of the present disclosure only the effluent of the first reaction vessel (4a) is added to the second reaction vessel and the polymerization is continued in the second vessel. The effluent (5b) of the second reaction vessel contains the final polymer and is fed to the work up unit (6). Instead of two reaction vessels as illustrated in FIG. 2, more than two reaction vessels may be connected in the same way. A fraction of effluent (5b) is directed in a recycle line stream (2) via cooling unit (8) to the monomer stream (1) and is combined with it to form reactant stream (3), which is introduced into the first reactor (4a) for further polymer production. Chain transfer agent may be added via CTA-feed (7) to the recycle stream (2) before or while the recycle stream (2) enters the cooling unit (8). Instead of feeding the recycle stream (2) into the monomer stream (1) as illustrated in FIG. 2 the recycle stream (2) may alternatively or additionally be fed directly to the first reactor (4a) or to effluent (5a) or introduced directly into the second reactor vessel (4b). Alternatively, or additionally, the recycle stream (2) may not be combined with the monomer stream (1) and may be fed directly to a reaction vessel, for example to either reaction vessel (4a) or reaction vessel (4b) or both. The recycle stream (2) may be fed continuously or intermittently for some time to (4a) and some time to (4b). Instead of, or in addition to, taking the recycle stream (2) from effluent (5b) it may also be taken from effluent (5a) or from both. In another embodiment two separate recycle streams are generated, one from effluent (5a) and another from effluent (5b). They may be fed through separate recycle lines or may be combined in a single recycle line and may be introduced into vessel (4a), into vessel (4b) or both, or into a monomer stream, or one of the recycle streams may be combined with the monomer feed stream (1) and the other one is fed directly to a reaction vessel.

FIG. 3 illustrates the embodiment of the process according to the present disclosure where the recycle stream (2) is taken from the effluent (5a) of the first reaction vessel (4a) before it enters the second reaction vessel (4b).

Instead of using reaction vessels in series, the reaction vessels of the polymerization unit (4) may also be arranged in parallel. The reactor effluents may be combined, for example, in a mixer or another reactor before or during solvent removal and work up of the polymer. Such an arrangement allows, for example, the production of multimodal polymers or polymer blends, for example “reactor blends” i.e. polymer blends obtained by wet mixing.

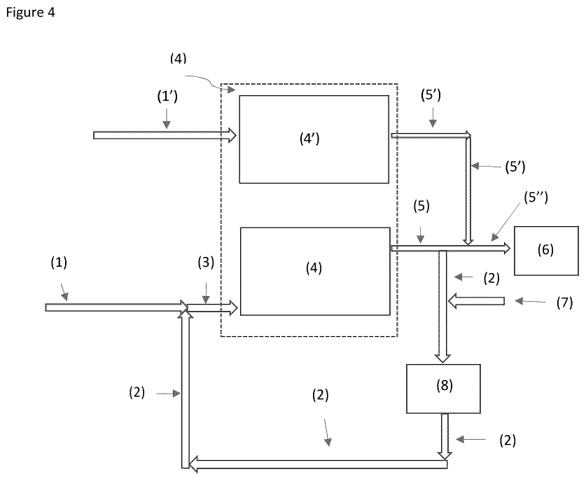

The recycle stream (2) may be created with the reaction mixture of one or more than one or all reaction vessels or from the combined effluents before they enter the devolatilization unit and before the catalyst is killed. The recycle stream may be directed to one or to all reaction vessels. An embodiment of such a parallel reactor process is illustrated in FIG. 4 to which is now referred. The first part of the process is in principle identical to the process illustrated in FIG. 1, however, a second monomer feed (1′) is introduced into a second polymerization unit (4′) and produces the product stream (5′). The product stream (5′) is combined with product stream (5) from the first polymerization unit (4) and forwarded to the work up section (6). The reaction mixture from the effluent is used for recycling before product stream (5) is combined with product stream (5′). The process illustrated in FIG. 4 only uses one recycle stream for the first polymerization unit. In one embodiment of this process both polymerization units (4) and (4′) may have their own recycle streams (2) and (2′) taken from effluents (5) and (5′), respectively. As described above, the recycle stream(s) may be fed directly into one or more reaction vessels of polymerization unit (4) or (4′) or both after or without having been combined with the monomer feed (1) or (1′).

### Examples

The present disclosure will now be illustrated further by examples without any intention to limit the disclosure to the specific examples presented.

### Test Methods

### Polymer Composition:

Fourier transformation infrared spectroscopy (FT-IR) was used to determine the composition of the copolymers according to ASTM D3900 (revision date 2017) for the C2/C3 ratio and D6047 (revision date 2017) for the diene content on pressed polymer films.

### Phase Angle Measurements:

The polymer branching was determined by phase angle measurements on a Montech MDR 3000 moving die rheometer with parameter Δδ. Δδ (expressed in degrees) is the difference between the phase angle δ measured at a frequency of 0.1 rad/s and the phase angle δ measured at a frequency of 100 rad/s determined by Dynamic Mechanical Analysis (DMA) at 125° C. Δδ is a measure for the presence of long-chain branches in the polymer structure. The lower the value of Δδ the more long-chain branches are present in the polymer and has been introduced by H. C. Booij, in Kautschuk+Gummi Kunststoffe, Vol. 44, No. 2, pages 128-130,1991, which is incorporated herein by reference.

### Molecular Weights:

The molecular weights (Mw, Mn, Mz) and the molecular weight distribution (MWD) can be determined by gel permeation size exclusion chromatography (GPC) using a Polymer Char GPC-IR from Polymer Characterization S. A, Valencia, Spain. The Size Exclusion Chromatograph is equipped with an online viscometer (Polymer CharV-400 viscometer), an online infrared detector (IR5 MCT), with 3 AGILENT PL OLEXIS columns (7.5×300 mm) and a Polymer Char autosampler. Universal calibration of the system is performed with polyethylene (PE) standards.

The polymer samples are weighed (in the concentration range of 0.3-1.3 mg/ml) into the vials of the PolymerChar autosampler. In the autosampler the vials are filled automatically with solvent (1,2,4-tri-chlorobenzene stabilized with 1 g/l di-tertbutylparacresol (DBPC)). The samples are kept in the high temperature oven (160° C.) for 4 hrs. After this dissolution time, the samples are automatically filtered by an in-line filter before being injected onto the columns. The chromatograph system is operated at 160° C. The flow rate of the 1,2,4-trichlorobenzene eluent is 1.0 mL/min.

### Mooney Viscosity:

The Mooney viscosity of the copolymer samples was measured according to ISO 289, revision date 2015, with biaxially strained PP (20 μm thickness) film, provided by Perfon B. V., Goor, The Netherlands. The measuring conditions were ML (1+4) @ 125° C.

### Polymerization:

A polymerization to produce an EPDM polymer was carried out generally as described in the section “General polymerization procedure” of WO 2005/090418 A1, incorporated herein by reference. Triisobutylaluminum was used instead of MAO-10T. The experimental the set up was essentially as illustrated in FIG. 2 with two liquid filled stirred tank reactors for solution polymerization connected in series. Both reactors (4a) and (4b) had a volume of 3 liters. This set up is used as a proof of principle experiment. Since the reactor volume has been found not to be critical, it is believed that the process can also be carried out in larger reactors with reactor volumes greater than 3 liters, for example in reactors having a volume of 4 to 4000 liters. The monomers and the solvent were fed together in one line (monomer stream (1)) to the first reaction vessel (4a). Catalyst and activators were fed in separate lines to the first reactor (4a). The effluent (5a) of the first reactor (4a) was fed to the second reactor (4b) and other than this effluent no other feeds were introduced to the second reactor (4b). A discharge line (5b) fed a fraction of the reactor effluent of the second reactor to a work-up unit (6) and the other fraction to the recycle line (2). The recycle line (2) was pumped through a heat exchanger of the cooling unit (8) to reduce its temperature. The recycle line (2) was then combined with the feed line (1) to produce a reactant stream (3), which entered the first reactor (4a) of the polymerization unit (4). Hydrogen was added as chain transfer agent to the feed line (1). The amount of hydrogen was adjusted to achieve the desired polymer Mooney viscosity as given in Table 1. No chain transfer agent (7) was added to the recycle stream, contrary to the illustration in FIG. 2.

The feed streams were purified by contacting them with various absorption media to remove catalyst-killing impurities such as water, oxygen and polar compounds and the process was continuous in all feed streams. Premixed solvent (a mixture of hexane isomers with a boiling point range of 65° C. to 70° C.), propene, ethylene, ENB and VNB, hydrogen and scavengers were precooled before being fed to the reactor. The solutions containing the catalyst and activator were fed separately to the reactor. The solvent feed rate was 29.1 liters/hour; ethylene feed rate was 30.2 moles/hour, propylene feed was 27.1 moles/hour, ENB feed was 966 millimoles/hour. The pressure was 20 barg. The polymerization was started by charging catalyst and activator to the system. The recycle flow was set at twice the feed rate. The feed rate is the sum of the monomer and solvent mass flow rates.

The polymer solution (reaction mixture) was continuously removed from the second reactor through a discharge line (5b) where a fraction the reaction mixture was fed to the recycle line (2) and the rest of the reaction mixture was fed to work up vessel where a solution of IRGANOX 1076 in iso-propanol was added to stop further polymerization and to stabilize the polymer. Residual monomers and solvent were removed by continuous steam stripping yielding the polymer crumb. The EPDM polymers obtained were dried batch wise on a mill. The composition of the EPDM polymer obtained by the process and further processing conditions are shown in Table 1.

TABLE 1
Polymerization details.

| Parameter | Result |
|---|---|
| Temperature of monomer and solvent feed [° C.] | 9.9 |
| Temperature of first reactor [° C.] | 89.8 |
| Temperature of second reactor [° C.] | 93.9 |
| Temperature of recycle stream after heat exchanger | 72.2 |
| Prod [g/h] | 1237 |
| C2 conversion [%] | 93 |
| H₂ [NL/h] | 0.03 |
| VNB [mmol/h] | 35 |
| Total solids discharge reactor 2 [%] | 10.8 |
| Mooney (ML 1 + 4, 125° C.) [MU] | 52 |
| C2 in polymer [wt. %] | 47.7 |
| ENB in polymer [wt. %] | 5.3 |
| VNB in polymer [wt. %] | 0.15 |
| Δδ [°] | 13.8 |
| Mn [kDa] | 61 |
| Mw [kDA] | 245 |
| Mz [kDa] | 760 |

In Table 1, “Prod” means the polymer production rate in grams per hour, “C2” means units derived from ethylene. The remainder of the EPDM polymer (other than units derived from C2, ENB and VNB) was made up of units derived from propylene.

As shown above an EPDM polymer with a weight averaged molecular weight of greater than 200.000 g/mole was produced with a monomer/solvent feed stream that had to be cooled down only to 10° C. and thus only moderate cooling of monomers and solvent was necessary.

1. A process of producing a polymer, comprising
(i) feeding a monomer stream containing the monomers for producing the polymer into a polymerization unit comprising at least one reaction vessel wherein at least one reaction mixture comprising a polymer is produced in a polymerization reaction in the presence of at least one solvent and at least one catalyst,
(ii) feeding at least a fraction of a reaction mixture produced in the polymerization unit comprising a polymer, catalyst and, optionally monomer, into a recycle line to form a recycle stream,
(iii) reducing the temperature of the recycle stream, and
(iv) feeding the recycle stream, after its temperature has been reduced, into the polymerization unit, the monomer stream or both,
wherein the polymer is an elastomer selected from (a) ethylene/alpha-olefin copolymers with at least 20% by weight of units derived from ethylene and which, optionally may further comprise units derived from at least one non-conjugated diene having from 6 to 30 carbon atoms, (b) polybutadienes and (c) butadiene copolymers with at least 50% by weight of units derived from butadiene.

2. The process of claim 1 further comprising repeating (ii) to (iv) continuously or intermittently.

3. The process of claim 1, wherein (ii) to (iv) are carried out once or more than once before a reaction mixture produced in the polymerization unit is subjected to work up for removing solvent and isolating the polymer.

4. The process of claim 1, wherein the flow rate of the recycle stream is faster than the flow rate of monomer stream.

5. The process of claim 1, wherein the retention time of the recycle stream, determined from the point where the reaction mixture is fed into the recycle line to form the recycle stream to the point where the recycle stream either enters the monomer stream or the reaction vessel, is shorter than the retention time of the polymerization unit, determined from the point where the monomer stream enters the reaction vessel to the point where the effluent of the reaction vessel exits the reaction vessel for polymer work up.

6. The process of claim 1, wherein the temperature of the recycle stream is reduced in a cooling unit comprising at least one heat exchanger.

7. The process of claim 1, wherein the temperature of the recycle stream is reduced in a cooling unit and no additional catalyst or activator or both are added to the recycle stream before the recycle stream has passed the cooling unit.

8. The process of claim 1, wherein the temperature of the monomer stream is lower than the temperature of the recycle stream after the temperature of the recycle stream has been reduced and wherein the temperature of the monomer stream is greater than −25° C. and up to 39° C.

9. The process of claim 1, wherein the temperature in the at least one stirred tank reactor during the polymerization reaction is between 60° C. and 120° C.

10. The process of claim 1, wherein the monomer stream comprises monomers and solvent.

11. The process of claim 1, wherein the polymerization unit comprises at least a first reaction vessel, comprising a first stirred tank reactor, and at least a second reaction vessel, comprising a second stirred tank reactor, connectable in series or in parallel, wherein a first reaction mixture is produced in the first reaction vessel in a polymerization reaction in the presence of at least one solvent and at least one catalyst and a second reaction mixture is produced in the second reaction vessel in a polymerization reaction in the presence of a solvent and at least one second catalyst and wherein the recycle stream comprises a fraction of at least the first or at least the second reaction mixture or both, and wherein the first polymerization catalyst is the same as the second polymerization catalyst or is a different catalyst.

12. The process of claim 1, further comprising adding chain transfer agent to the recycle stream before the temperature of the recycle stream is reduced in the cooling unit and wherein the addition of the chain transfer agent is continuously or intermittently or a single dose addition.

13. The process of claim 1, wherein at least the at least one reaction vessel is pressurized to keep the monomers dissolved or in a liquid state.

14. The process of claim 1, wherein the polymer is an ethylene/alpha-olefin copolymer comprising units derived from ethylene and propylene, preferably having a weight average molecular weight of at least 50.000 g/mole, as determined by gel permeation chromatography, and wherein the copolymer further comprises units derived from at least one non-conjugated diene having from 6 to 30 carbon atoms.

15. The process of claim 1, wherein the polymerization reaction is carried out as slurry polymerization or solution polymerization.

16. The process of claim 1, wherein at least one non-conjugated diene having from 6 to 30 carbon atoms is selected from dicyclopentadiene (DCPD), 5-ethylidene-2-norbornene (ENB), 5-vinyl-2-norbornene (VNB) and a combination thereof.

17. The process of claim 1, wherein at least one reaction vessel of the polymerization unit has a reactor volume of at least 4 liters.

18. The process of claim 1, further comprising
(v) comprising removing solvent and isolating the polymer from a reaction mixture produced in the polymerization unit.

19. The process of claim 18, wherein the solvent is removed and/or the polymer is isolated by feeding a reaction mixture produced in the polymerization unit to at least one work up section for removing the solvent and isolating the polymer.

20. The process of claim 7, wherein no additional catalyst or activator or both is added to the recycle stream at all.
